(19) United States
(12) Patent Application Publication
(10) Pub. No.: US 2010/0073393 A1
(43) Pub. Date: Mar. 25, 2010

(54) CONTENT DETECTION OF A PART OF AN IMAGE

(75) Inventors: Sudip Saha, Bangalore (IN); Anil Yekkala, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/442,719

(22) PCT Filed: Sep. 25, 2007
(86) PCT No.: PCT/IB2007/053888

§ 371 Date: Nov. 24, 2009

(30) Foreign Application Priority Data
Sep. 28, 2006 (EP) 06121431.8

(51) Int. Cl. G09G 5/02

(52) U.S. Cl. 345/589

(57) ABSTRACT

Methods for image content detection calculate (16), for a pixel, an estimated intensity of the pixel and calculate (17), for the pixel, an actual intensity of this pixel and detect (18) whether a function of the estimated intensity and the actual intensity fulfils an intensity condition and generate (19), in response to an intensity condition detection result, a pixel content detection signal. These intensities are functions of the color value of the pixel. These methods perform well for a blue content (sky like cloudy sky and non-cloudy sky) and are used for content based classifications and automatic selections of images. To improve an efficiency and/or a success rate, the methods may further detect (15) whether color values fulfill color conditions. The methods may further detect (32,33) whether functions of numbers of pixels from groups of pixels fulfill block threshold conditions, to be able to generate block content detection signals in response to block threshold condition detection results.

### FIELD OF THE INVENTION

The invention relates to a method for detecting a content of at least a part of an image comprising pixels, to a computer program product, to a medium, to a processor, to a device and to a system.

Examples of such a device and of such a system are consumer products, such as video players, video recorders, personal computers, mobile phones and other handhelds, and non-consumer products. Examples of such a content are contents of a specific type and contents of a desired type.

### BACKGROUND OF THE INVENTION

EP 1 318 475 B1 discloses a method and a system for selectively applying an enhancement to an image, and discloses, in its FIG. 10 and its paragraph 0025, a method for detecting subject matter such as clear blue sky or lawn grass. Thereto, each pixel is assigned a subject matter belief value in a color and texture pixel classification step based on color and texture features by a suitably trained multi layer neural network.

This method and this system require a suitably trained multi layer neural network and are therefore relatively complex.

### SUMMARY OF THE INVENTION

It is an object of the invention, inter alia, to provide a relatively simple method.

Further objects of the invention are, inter alia, to provide a relatively simple computer program product, a relatively simple medium, a relatively simple processor, a relatively simple device and a relatively simple system.

A method for detecting a content of at least a part of an image comprising pixels, each pixel being defined by at least one color value, is defined by comprising
a first step of, for a pixel, calculating an estimated intensity of the pixel, which estimated intensity is a function of the at least one color value,
a second step of, for the pixel, calculating an actual intensity of this pixel, which actual intensity is another function of the at least one color value,
a third step of detecting whether a function of the estimated intensity and the actual intensity fulfils at least one intensity condition, and
a fourth step of, in response to an intensity condition detection result, generating a pixel content detection signal.

The at least one color value for example comprises twenty-four bits, eight bits for indicating a red value, eight further bits for indicating a blue value and eight yet further bits for indicating a green value. Alternatively, the at least one color value for example comprises three separate values in the form of a red value, a blue value and a green value, each one of these values being defined by for example eight or sixteen or twenty-four bits. Other and/or further values and other and/or further numbers of bits are not to be excluded.

The first step calculates, for a pixel, an estimated intensity of the pixel, which estimated intensity is a function of the color value. The second step calculates, for the pixel, an actual intensity of this pixel, which actual intensity is another function of the color value.

The third step detects whether a function of I) the estimated intensity and II) the actual intensity fulfils an intensity condition. Thereto, in practice, for example a difference between the intensities is compared with a maximum difference value. The fourth step generates, in response to an intensity condition detection result, a pixel content detection signal. This pixel content detection signal may be a simple yes/no signal or a more sophisticated signal that for example further indicates a degree of fulfillment.

As a result, a simple method for image content detection has been created. Especially, but not exclusively, for a non-artificial content from nature, the method has proven to perform well. For example a blue content such as a sky like a cloudy sky and a non-cloudy sky is detected well. The method is for example used for a content based classification and/or an automatic selection of an image and/or an outdoor image detection and/or a sky detection for a 3-D image to estimate a depth of one or more pixels and/or a detection of a background useful for an MPEG encoder.

An embodiment of the method is defined by claim 2. Preferably, but not exclusively, in response to a calculated estimated intensity, a calculated estimated intensity signal is generated, and/or in response to a calculated actual intensity, a calculated actual intensity signal is generated, and/or in response to an intensity condition detection result, an intensity condition signal is generated.

An embodiment of the method is defined by claim 3. Preferably, but not exclusively, the fifth step is added to the first to fourth steps to improve an efficiency and to possibly improve a success rate.

The method is for example only performed for those pixels that have fulfilled the color condition. Thereto, in practice, for example the red, blue and green values are compared with each other and/or with functions of red, blue and green values and/or with predefined values. Then, only for pre-selected, interesting pixels, the intensities need to be calculated. This way, the method has got an improved efficiency and may further show an improved success rate.

For example when detecting a blue content, the blue value is preferably larger than the green value and the red value is preferably smaller than a third of a sum of the three values.

An embodiment of the method is defined by claim 4. Preferably, but not exclusively, the sixth and seventh steps are added to the first to fifth steps to improve a success rate.

The at least one color value comprises at least two values, such as for example the red, blue and green values. The estimated intensity is a function of for example one of these values, and the actual intensity is a function of for example all these values. The result of the method is checked via the further color condition for being reliable or not. This way, the method shows an improved success rate. The further pixel content detection signal indicates the reliability or the unreliability of the pixel content detection signal. This further pixel content detection signal may be a simple yes/no signal or a more sophisticated signal that for example further indicates a degree of reliability.

For example when detecting a blue content, the estimated intensity is preferably a linear or quadratic equation of the blue value and the actual intensity is for example equal to a sum of 30% (more precisely: 29.9%, more general: 25-35%) of the red value and 59% (more precisely: 58.7%, more general: 54-64%) of the green value and 11% (more precisely: 11.4%, more general: 6-16%) of the blue value, without excluding other and/or further and/or more precise percentages and without excluding other and/or further equations and formulas. The further color condition for example requires that the blue value is larger than each one of the green and the red values.

An embodiment of the method is defined by claim 5. Preferably, but not exclusively, the eighth, ninth and tenth steps are added to the first to seventh steps to perform the content detection not only for one or several pixels but for a group of pixels.

The group of pixels forms for example a block within the image, or forms a selection from all pixels that together form the image. Such a selection may comprise neighboring pixels and non-neighboring pixels. For example, the group of pixels may comprise every second or third pixel of a set of rows of the mage and may comprise every second or third pixel of a set of columns of the image.

The eighth step detects, for the group of pixels, whether a function of a number of pixels from the group of pixels, for which number of pixels confirming pixel content detection signals have been generated, fulfils the block threshold condition, which block threshold condition is defined by the block threshold value. Thereto, in practice, for example this number is counted and processed and then compared with the block threshold value, for example to determine a percentage of particular pixels within a block of pixels.

For example when detecting a blue content, those pixels for which confirming pixel content detection signals have been generated might be called “sky” pixels. A proportion of “sky” pixels in a block comprising a group of pixels might need to be larger than a first percentage such as for example 50%.

The ninth step detects, for the group of pixels, whether a function of a number of pixels from the group of pixels, for which number of pixels confirming further pixel content detection signals have been generated, fulfils the further block threshold condition, which further block threshold condition is defined by the further block threshold value. Thereto, in practice, for example this number is counted and processed and then compared with the further block threshold value.

For example when detecting a blue content, those pixels for which confirming further pixel content detection signals have been generated (those pixels that have fulfilled the further color condition) might be called “blue sky” pixels. A proportion of “blue sky” pixels in a block comprising a group of pixels might need to be larger than a second percentage such as for example 25%.

The tenth step generates, in response to the block threshold condition detection result and the further block threshold condition detection result, the block content detection signal. This block content detection signal may be a simple yes/no signal or a more sophisticated signal that for example further indicates a degree of fulfillment.

For example when detecting a blue content, in case the proportion of “sky” pixels in the block is larger than the first percentage such as for example 50% and in case the proportion of “blue sky” pixels in the block is larger than the second percentage such as for example 25%, the block might be considered to contain a sky. In that case, the image might be considered to contain a sky.

Of course, the eight and ninth and tenth steps may be repeated for different blocks comprising different groups of pixels. For example when detecting a blue content, a first block of the image is to be checked. In case a first block does not contain a blue content as defined by the first to fourth and possibly the fifth and/or sixth and/or seventh steps, a second block of the image is to be checked, etc. These different blocks may be located anywhere in the image, however preferably, for example for sky detection, the different blocks will be at an upper side of the image, owing to the fact that usually the sky will have a higher location and the non-sky will have a lower location.

A computer program product for performing the steps of the method is defined by claim 6. A medium for storing and comprising the computer program product is defined by claim 7. A processor for performing the steps of the method is defined by claim 8. Such a processor for example comprises first and second calculation means and detection means and generation means. A device for detecting a content of at least a part of an image comprising pixels is defined by claim 9. Such a device for example comprises first and second calculators and a detector and a generator. A system comprises the device as claimed in claim 9 and further comprises a memory for storing color values of pixels of images. Alternatively, the memory may form part of the device.

Embodiments of the computer program product and of the medium and of the processor and of the device and of the system correspond with the embodiments of the method.

An insight might be, inter alia, that, for a relatively simple content detection of a group of pixels, the fact that there might be a negative correlation between color-ness and intensity, such as a negative correlation of −0.7 between blueness and intensity, is to be taken into account. A basic idea might be, inter alia, that per pixel, a function of a calculated estimated intensity and a calculated actual intensity needs to fulfill at least one intensity condition.

A problem, inter alia, to provide a relatively simple method for content detection of at least a part of an image, is solved. A further advantage might be, inter alia, that content based classifications and automatic selections of images and outdoor image detections show an improved success rate.

These and other aspects of the invention are apparent from and will be elucidated with reference to the embodiments described hereinafter.

### BRIEF DESCRIPTION OF THE DRAWINGS

In the drawings:

FIG. 1 shows a flow chart of a method,

FIG. 2 shows a block diagram of a system comprising a processor, and

FIG. 3 shows a block diagram of a system comprising a device.

### DETAILED DESCRIPTION

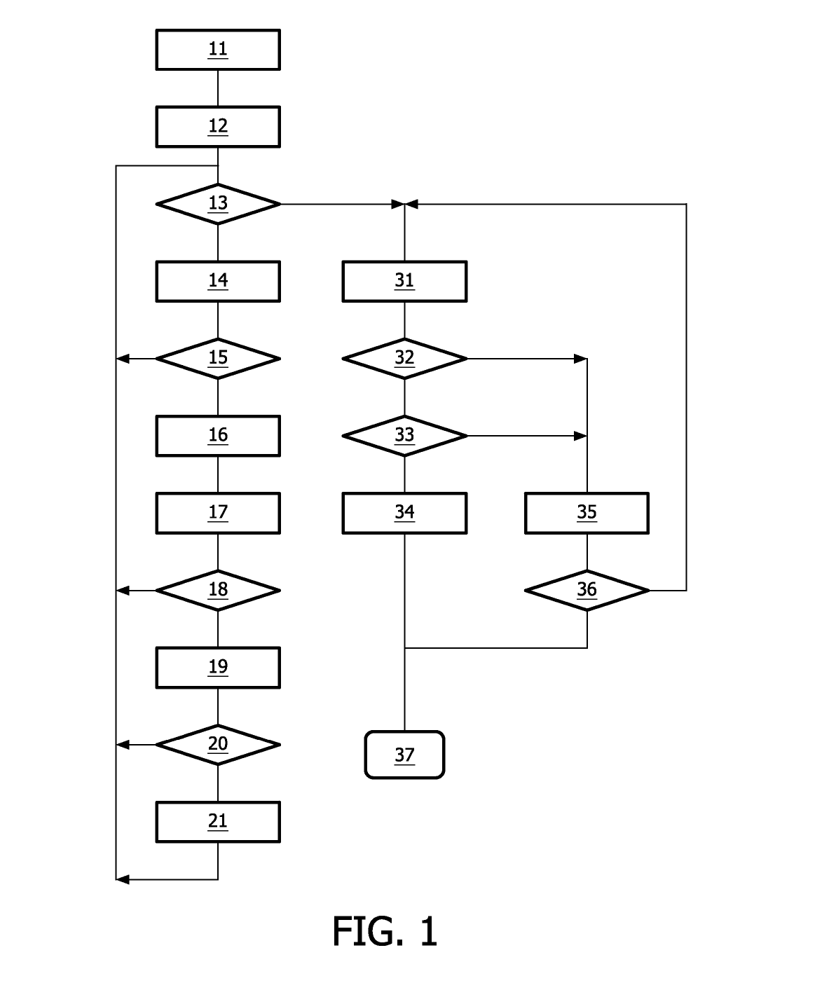

In the FIG. 1, the following blocks have the following meaning:
Block 11: Start. Convert image information into a color value per pixel and/or get image information in the form of a color value per pixel, the color value comprising a red value, a blue value and a green value.
Block 12: Divide the image into blocks, each block comprising a group of pixels.
Block 13: Have all pixels been checked and/or read? If yes, goto block 31, if no, goto block 14.
Block 14: Obtain the color value comprising the red value, blue value and green value of a pixel, if not already available from block 11.
Block 15: Detect whether the color value fulfils one or more color conditions defined by one or more threshold values. If yes, goto block 16, if no, goto block 13.
Block 16: Calculate an estimated intensity of the pixel, which estimated intensity is a function of the color value.
Block 17: Calculate an actual intensity of this pixel, which actual intensity is another function of the color value.
Block 18: Detect whether a function of the estimated intensity and the actual intensity fulfils one or more intensity conditions. If yes, goto block 19, if no, goto block 13.
Block 19: In response to a confirming intensity condition detection result, generate a pixel content detection signal.
Block 20: The color value comprises at least two values, the estimated intensity is a function of at least one of the at least two values, and the actual intensity is a function of the at least two values. Detect whether the at least one of the at least two values fulfils one or more further color condition defined by one or more further threshold value. If yes, goto block 21, if no, goto block 13.
Block 21: In response to a confirming further color condition detection result, generate a further pixel content detection signal.
Block 31: Select a block comprising a group of pixels that has not been selected before.
Block 32: Detect whether a function of a number of pixels from the group of pixels, for which number of pixels confirming pixel content detection signals have been generated, fulfils a threshold condition, which block threshold condition is defined by one or more block threshold value. If yes, goto block 33, if no, goto block 35.
Block 33: Detect whether a function of a number of pixels from the group of pixels, for which number of pixels confirming further pixel content detection signals have been generated, fulfils a further block threshold condition, which further block threshold condition is defined by one or more further block threshold value. If yes, goto block 34, if no, goto block 35.
Block 34: In response to a confirming block threshold condition detection result and a confirming further block threshold condition detection result, generate a block content detection signal.
Block 35: In response to a non-confirming block threshold condition detection result and/or a non-confirming further block threshold condition detection result, generate a block content non-detection signal or do not generate the block content detection signal.
Block 36: Have all blocks been checked? If yes, goto block 37, if no, goto block 31.
Block 37: End.

At block 11, the image information of the image is converted into a color value per pixel and/or the image information in the form of a color value per pixel is got. The color value may comprise a red value, a blue value and a green value, each defined by a number of bits, without excluding other and/or further options. In case of a value being defined by eight bits, the value may have a size from 0 to 255.

At block 12, a step of dividing the image into blocks is performed, and the image is divided into blocks, for example fifteen rows and fifteen columns of blocks. The image may for example have a resolution of 1024×768 pixels. Larger resolutions may be scaled down. Alternatively, the image may be divided into a smaller number of blocks that cover only a part of the image. This all without excluding other and/or further options.

At block 15, a step of, for the pixel, detecting whether the at least one color value fulfils at least one color condition defined by at least one threshold value, is performed.

To detect for example a blue content such as a sky like a cloudy sky and a non-cloudy sky, the following color conditions and threshold values might be used: ((blue value>green value) AND (red value<0.33*(sum of red value and blue value and green value))). Other color conditions and threshold values are not to be excluded.

At block 16, a step of, for the pixel, calculating an estimated intensity of the pixel, which estimated intensity is a function of the at least one color value, is performed. To detect for example a blue content such as a sky like a cloudy sky and a non-cloudy sky, the estimated intensity is preferably a linear or quadratic equation of the blue value, for example x*(blue value)+y, or x*(blue value)+y*(blue value)+z etc. In the latter case, x=0.1 and y=16.7 and z=641.1, without excluding other numbers.

At block 17, a step of, for the pixel, calculating an actual intensity of this pixel, which actual intensity is another function of the at least one color value, is performed. To detect for example a blue content such as a sky like a cloudy sky and a non-cloudy sky, the actual intensity is for example equal to a sum of 30% (more precisely: 29.9%, more general: 25-35%) of the red value and 59% (more precisely: 58.7%, more general: 54-64%) of the green value and 11% (more precisely: 11.4%, more general: 6-16%) of the blue value, without excluding other and/or further and/or more precise percentages and without excluding other and/or further equations and formulas.

At block 18, a step of detecting whether a function of the estimated intensity and the actual intensity fulfils at least one intensity condition, is performed. This is for example done by comparing a difference between the intensities with a maximum difference value or by comparing a square of the difference or a difference of squares of the intensities with further difference values etc.

At block 20, a step of, for the pixel for which a confirming pixel content detection signal has been generated, detecting whether the at least one of the at least two values fulfils at least one further color condition defined by at least one further threshold value, is performed. The further color condition for example requires that the blue value is larger than each one of the green and the red values.

At block 32, a step of, for a group of pixels, detecting whether a function of a number of pixels from the group of pixels, for which number of pixels confirming pixel content detection signals have been generated, fulfils a block threshold condition, which block threshold condition is defined by at least one block threshold value, is performed. This is for example done by counting and processing this number and then comparing it with the block threshold value. For example when detecting a blue content, those pixels for which confirming pixel content detection signals have been generated might be called “sky” pixels.

At block 33, a step of, for the group of pixels, detecting whether a function of a number of pixels from the group of pixels, for which number of pixels confirming further pixel content detection signals have been generated, fulfils a further block threshold condition, which further block threshold condition is defined by at least one further block threshold value, is performed. This is for example done by counting and processing this number and then comparing it with the further block threshold value. For example when detecting a blue content, those pixels for which confirming further pixel content detection signals have been generated might be called “blue sky” pixels.

For example when detecting a blue content, in case the proportion of “sky” pixels in the block is larger than the a percentage such as for example 50% and in case the proportion of “blue sky” pixels in the block is larger than a second percentage such as for example 25%, the block might be considered to contain a sky. In that case, the image might be considered to contain a sky.

So, firstly decisions are taken based on pixel color properties (color conditions and/or intensity conditions). Secondly, block level and global decisions might be taken (block threshold conditions).

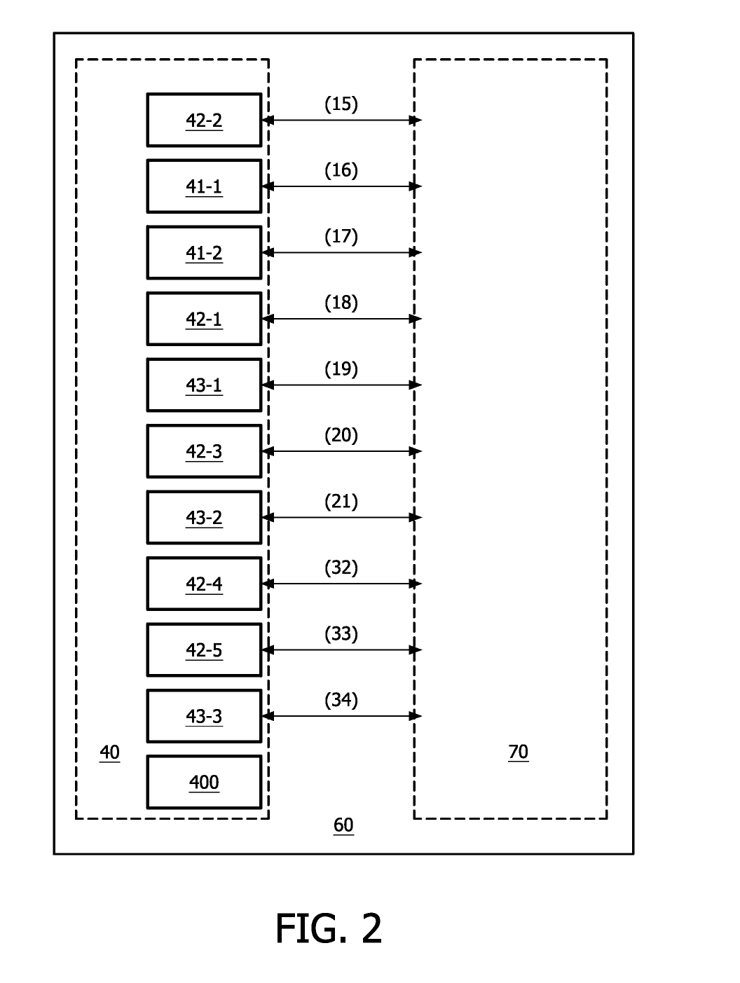

In the FIG. 2, a block diagram of a system 60 comprising a processor 40 and a memory 70 is shown. Such a system is for example a processor-memory system. The processor 40 comprises first calculation means 41-1 for performing the first step 16, second calculation means 41-2 for performing the second step 17, first detection means 42-1 for performing the third step 18, first generation means 43-1 for performing the fourth step 19, second detection means 42-2 for performing the fifth step 15, third detection means 42-3 for performing the sixth step 20, second generation means 43-2 for performing the seventh step 21, fourth detection means 42-4 for performing the eighth step 32, fifth detection means 42-5 for performing the ninth step 33 and third generation means 43-3 for performing the tenth step 34.

Thereto, control means 400 control the means 41-43 and control the memory 70. The means 41-43 and 400 are for example individually coupled to the memory 70 as shown, or are together coupled to the memory 70 via coupling means not shown and controlled by the control means 400. Several calculation means might be integrated into a single calculation means, several detection means might be integrated into single detection means, and several generation means might be integrated into single generation means. Calculation means are for example realized through a calculator. Detection means are for example realized through a comparator or through a calculator. Generation means are for example realized through an interface or a signal provider or form part of an output of other means.

The steps are numbered in the FIG. 2 between brackets located above couplings between the means 41-43 and the memory 70 to indicate that usually for performing the steps the means 41-43 will consult the memory 70 and/or load information from the memory 70 and/or process this information and/or write new information into the memory 70 etc. and all under control by the control means 400.

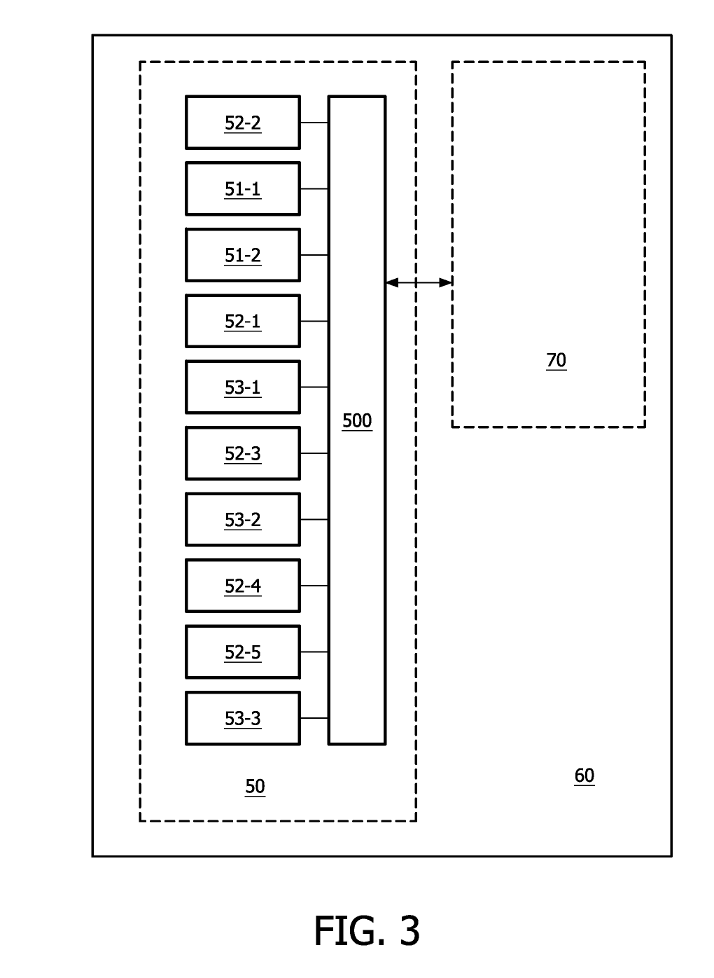

In the FIG. 3 a block diagram of a system 60 comprising a device 50 and a memory 70 is shown. The device 50 comprises a first calculator 51-1 for performing the first step 16, a second calculator 51-2 for performing the second step 17, a first detector 52-1 for performing the third step 18, a first generator 53-1 for performing the fourth step 19, a second detector 52-2 for performing the fifth step 15, a third detector 52-3 for performing the sixth step 20, a second generator 53-2 for performing the seventh step 21, a fourth detector 52-4 for performing the eighth step 32, a fifth detector 52-5 for performing the ninth step 33, and a third generator 53-3 for performing the tenth step 34.

Thereto, a controller 500 controls the units 51-53 and controls the memory 70. The units 51-53 are individually coupled to the controller 500 which is further coupled to the memory 70 as shown, or a separate coupler not shown and controlled by the controller 500 might be used for coupling the units 51-53 and the controller 500 and the memory 70. Several calculators might be integrated into a single calculator, several detectors might be integrated into a single detector, and several generators might be integrated into a single generator. Detectors are for example realized through a comparator or through a calculator. Generators are for example realized through an interface or a signal provider or form part of an output of other units.

Usually for performing the steps the units 51-53 will consult the memory 70 and/or load information from the memory 70 and/or process this information and/or write new information into the memory 70 etc. and all under control by the controller 500.

Summarizing, methods for image content detection calculate (16), for a pixel, an estimated intensity of the pixel and calculate (17), for the pixel, an actual intensity of this pixel and detect (18) whether a function of the estimated intensity and the actual intensity fulfils an intensity condition and generate (19), in response to an intensity condition detection result, a pixel content detection signal. These intensities are functions of the color value of the pixel. These methods perform well for blue content (sky like cloudy sky and non-cloudy sky) and are used for content based classifications and automatic selections of images. To improve an efficiency and/or a success rate, the methods may further detect (15) whether color values fulfill color conditions. The methods may further detect (32,33) whether functions of numbers of pixels from groups of pixels fulfill block threshold conditions, to be able to generate block content detection signals in response to block threshold condition detection results.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for detecting a content of at least a part of an image comprising pixels, each pixel being defined by at least one color value, which method comprises
a first step (16) of, for a pixel, calculating an estimated intensity of the pixel, which estimated intensity is a function of the at least one color value,
a second step (17) of, for the pixel, calculating an actual intensity of this pixel, which actual intensity is another function of the at least one color value,
a third step (18) of detecting whether a function of the estimated intensity and the actual intensity fulfils at least one intensity condition, and
a fourth step (19) of, in response to an intensity condition detection result, generating a pixel content detection signal.

2. A method as claimed in claim 1, wherein
the first step (16) comprises a sub-step of, in response to a calculated estimated intensity, generating a calculated estimated intensity signal,
the second step (17) comprises a sub-step of, in response to a calculated actual intensity, generating a calculated actual intensity signal, and
the third step (18) comprises a sub-step of, in response to an intensity condition detection result, generating an intensity condition signal.

3. A method as claimed in claim 1, further comprising
a fifth step (15) of, for the pixel, detecting whether the at least one color value fulfils at least one color condition defined by at least one threshold value, the first and second steps (16,17) being performed in case the pixel has fulfilled the at least one color condition.

4. A method as claimed in claim 3, wherein the at least one color value comprises at least two values, which estimated intensity is a function of at least one of the at least two values, which actual intensity is a function of the at least two values, the method further comprising
a sixth step (20) of, for the pixel for which a confirming pixel content detection signal has been generated, detecting whether the at least one of the at least two values fulfils at least one further color condition defined by at least one further threshold value, and
a seventh step (21) of, in response to a further color condition detection result, generating a further pixel content detection signal.

5. A method as claimed in claim 4, further comprising
an eighth step (32) of, for a group of pixels, detecting whether a function of a number of pixels from the group of pixels, for which number of pixels confirming pixel content detection signals have been generated, fulfils a block threshold condition, which block threshold condition is defined by at least one block threshold value,
a ninth step (33) of, for the group of pixels, detecting whether a function of a number of pixels from the group of pixels, for which number of pixels confirming further pixel content detection signals have been generated, fulfils a further block threshold condition, which further block threshold condition is defined by at least one further block threshold value, and
a tenth step (34) of, in response to a block threshold condition detection result and a further block threshold condition detection result, generating a block content detection signal.

6. A computer program product for performing the steps of the method as claimed in claim 1.

7. A medium for storing and comprising the computer program product as claimed in claim 6.

8. A processor (40) for performing the steps of the method as claimed in claim 1, which processor (40) comprises
first calculation means (41-1) for performing the first step (16),
second calculation means (41-2) for performing the second step (17),
detection means (42-1) for performing the third step (18), and
generation means (43-1) for performing the fourth step (19).

9. A device (50) for detecting a content of at least a part of an image comprising pixels, each pixel being defined by at least one color value, which device (50) comprises
a first calculator (51-1) for, for a pixel, calculating an estimated intensity of this pixel, which estimated intensity is a function of the at least one color value,
a second calculator (51-2) for, for the pixel, calculating an actual intensity of this pixel, which actual intensity is another function of the at least one color value,
a detector (52-1) for detecting whether a function of the estimated intensity and the actual intensity fulfils at least one intensity condition, and
a generator (53-1) for, in response to an intensity condition detection result, generating a pixel content detection signal.

10. A system (60) comprising the device (50) as claimed in claim 9 and further comprising a memory (70) for storing color values of pixels of images.
